(19) United States
(12) Patent Application Publication
(10) Pub. No.: US 2005/0281398 A1
(43) Pub. Date: Dec. 22, 2005

(54) Methods, systems, and storage mediums for providing an optimized call routing service

(76) Inventor: Gerald A. Starling, Hampton, GA (US)

Correspondence Address: Philmore H. Colburn II;Cantor Colburn LLP, 55 Griffin Road South, Bloomfield, CT, 06002, US

(21) Appl. No.: 10/869,248

(22) Filed: Jun. 15, 2004

(51) Int. Cl. H04M 15/00

(52) U.S. Cl. 379/114.02; 379/114.01

(57) ABSTRACT

Exemplary embodiments relate to methods, systems, and storage mediums for providing call routing services. The method includes retrieving vendor pricing data in response to a call received from a caller. The call seeks termination at a destination party number. The method also includes retrieving customer preference data for the caller, analyzing the vendor pricing data and the customer preference data in light of the destination party number, generating a call routing plan resulting from the analyzing, and executing the call in accordance with the call routing plan.

### BACKGROUND OF INVENTION

Embodiments of the invention relate generally to telecommunications services, and more particularly, to methods, systems, and storage mediums for providing an optimized call routing service.

Telecommunications service providers offer a variety of different service plans and packages to their customers in an effort to stay competitive with, or gain an advantage over, its rivals. Customers are often inundated with promotional and fixed pricing information such as discounted rates that are based upon the time of day (e.g., after 5:00 p.m.), day of week (e.g., weekday versus weekend), among other criteria. These discounts may also vary dramatically from one service provider to the next. If given an opportunity and the necessary information (e.g., access to comparative pricing plans across available service providers), many cost-conscious service users might be better equipped to select a plan and a service provider that best meet their unique needs. Furthermore, these service users may also benefit from a service that adaptively allocates the routing of their calls among multiple vendors/carriers that offer the best rates.

What is needed, therefore, is a way to optimize the routing of calls placed by telecommunications service users that may be tailored to their existing, as well as future, service needs.

### SUMMARY OF INVENTION

The above disadvantages and shortcomings are overcome or alleviated by methods, systems, and storage mediums for providing an optimized call routing service. Methods include retrieving vendor pricing data in response to a call received from a customer of a telecommunications service provider. The call seeks termination at a destination party number. Methods also include retrieving customer preference data for the customer, analyzing the vendor pricing data and the customer preference data in light of the destination party number, generating a call routing plan resulting from the analyzing, and executing the call in accordance with the call routing plan.

Systems for providing an optimized call routing service include a service control server storing vendor pricing data and customer preference data. In response to a call received from a customer of a telecommunications service provider, the service control server retrieves the vendor pricing data and the customer preference data. Systems also include an analysis engine executing on the service control server. The analysis engine analyzes the vendor pricing data and the customer preference data in light of a destination party number associated with the call, and generates a call routing plan resulting from the analysis. Systems further include at least one vendor system in communication with said service control server. The vendor system is identified in the call routing plan and executes the call in accordance with the call routing plan.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram of a system upon which the call routing system may be implemented in exemplary embodiments; and

FIG. 2 is a flowchart describing a process for activating a call routing service account that is initiated over a public switched telephone network (PSTN) in exemplary embodiments;

FIG. 3 illustrates a sample provisioning record created by the call routing system in exemplary embodiments;

FIG. 4 is a flowchart describing a process for activating a call routing service account that is either initiated over a packet-switched network or by a manual process exemplary embodiments; and

FIG. 5 is a flowchart describing a process for implementing the call routing system in exemplary embodiments.

### DETAILED DESCRIPTION

According to exemplary embodiments, the call routing system provides customized routing of calls for service customers in order to meet their specific dial plan needs and reduces costs by routing calls via specific carriers, or the internal routes of a service provider, based upon pre-established criteria such as the time of day, day of week, time of year, and percentage allocations. Using these criteria, carrier information is evaluated in light of customer preferences and calling information, and an optimized call routing plan is generated therefrom. The calling plan specifies a particular vendor through which the call will be transmitted. While the call routing services are described herein with respect to business customers, it will be understood that these services may be offered to residential customers as well.

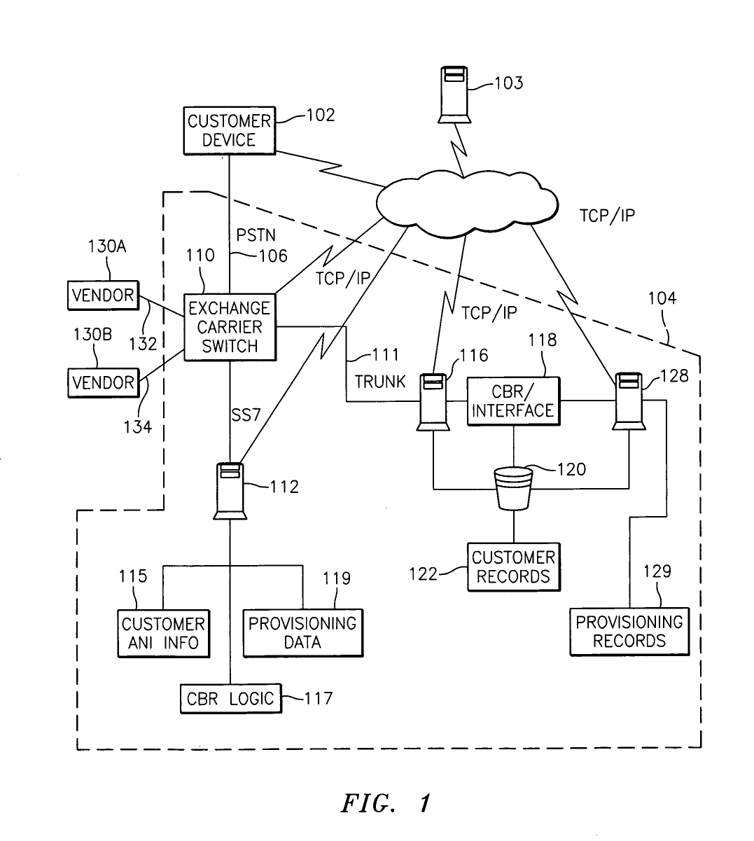

Turning now to FIG. 1, a system upon which the call routing system (also referred to herein as “customer best routing” (CBR) system) may be implemented will now be described. In exemplary embodiments, a customer device 102, operated by a customer (also referred to herein as “requesting party” and “calling party”) of a telecommunications service provider, is shown in the system of FIG. 1. The telecommunications service provider provides long distance telephone services to residential and business customers for a specified geographic region. The customer communicates with the telecommunications service provider using customer device 102. Customer device 102 may be a telephone, personal computer, or web-enabled mobile telephone. Customer device 102 communicates with host system 104 via a public switched telephone network (PSTN) 106 or a packet-switched network such as network 108, depending upon the nature of the customer device 102.

In exemplary embodiments, the telecommunications service provider, through host system 104, also provides the call routing services described herein. However, the telecommunications service provider may outsource a portion of these services to a third party system such as an application service provider (ASP) under an agreement.

The system shown in FIG. 1 also includes a billing server 103 in communication with host system 104 via network 108. Billing server 103 executes a billing application for tracking the fees associated with the call routing system. A customer may be charged a fee for each minute of use similar to the fees associated with existing long distance telephone services. This usage may be tracked by host system 104 and customers may be billed via a billing application executing on server 103. Customers may be notified in their bills (or by other means) of any savings realized as a result of using the call routing services.

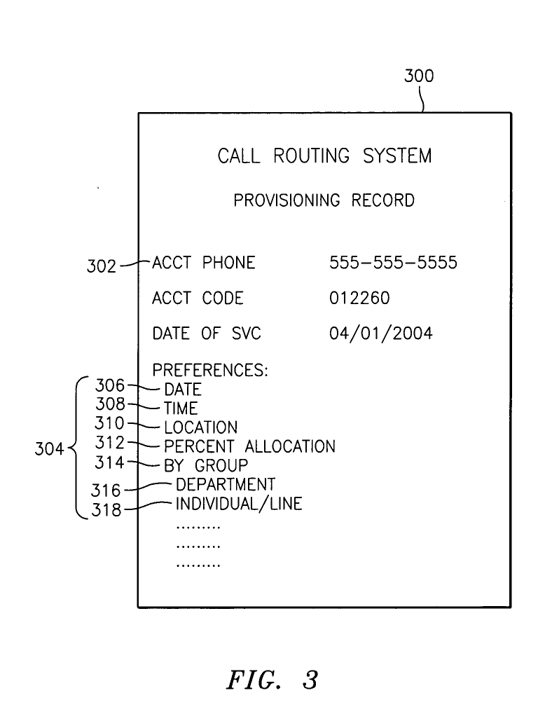

Also as shown in the system of FIG. 1, billing server 103 is outside of host system 104 for security reasons (e.g., an extra layer of security may be provided between network 108 and billing server 103 in order to protect confidential customer and billing data). However, it is not necessary that billing server 103 reside outside of host system 104. With proper security systems/software in place, it is contemplated that billing server 103 may reside within host system 104. Billing server 103 receives provisioning order data from host system 104, which includes call routing system account information for facilitating the billing activities associated with these services. This provisioning data may be stored internally in server 103 or may be stored in a memory location separate from server 103 that is logically addressable to server 103. The type of data that may be found in a provisioning order received at server 103 is shown generally in the provisioning record 300 of FIG. 3 and is described further herein.

As indicated above, a packet-switched network 108 is also shown in the system of FIG. 1. Network 108 may include any suitable network such as an Intranet, Extranet, or the Internet and enables entities associated with the call routing system to communicate with one another as will be described further herein.

Also included in the system of FIG. 1 are vendors 130A and 130B, which communicate with host system 104 via primary rate interface (PRI) trunks 132 and 134, respectively. PRI trunks 132 and 134 may be DS1 lines or T1 lines having a channel reserved for primary rate interface (PRI) signaling. Vendors 130A and 130B refer to telecommunications carrier entities which provide telecommunications transport services to customers. Vendors 130A and 130B, for example, may be incumbent local exchange carriers (ILECs) such as AT&T® of New York, N.Y. or Sprint® of Kansas City, Mo. Host system 104 acquires rate information for vendors 130A and 130B and stores it for use in implementing the call routing services described herein. For example, vendor 130A may offer discounted rates for calls to the Midwest between the hours of 7 and 9 p.m. on weekdays.

Host system 104 includes an exchange carrier switch 110, a service control server 112, a resource server 116, and a provisioning server 128. Exchange carrier switch 110 may comprise a high capacity switching system designed to assist the networks of interexchange carriers (e.g., host system 104). Exchange carrier switch 110 utilizes hardware and software capable of handling large capacity voice and data communications for long distance telecommunications customers. Hardware utilized by exchange carrier switch 110 may include the DMS 250™ by Nortel Networks Corporation of Brampton, Ontario. When a long-distance call is placed by an individual in a telecommunications environment, a local exchange carrier (not shown) associated with the individual queries a national database (not shown) to determine which carrier enterprise services that particular number. In the system of FIG. 1, exchange carrier switch 110 is determined to be the carrier (e.g., service provider) for the long distance number that was dialed.

Exchange carrier switch 110 also communicates with service control server 112 utilizing, e.g., Signaling Service No. 7 (SS7) protocol, which is described in “Telecommunications-Signaling System No. 7 (SS7)-General Information,” T1.110, ANSI, 1992. Service control server 112 refers to a centralized database server that provides services such as long distance number translation (e.g., sorting call handling and routing information for services executed by switching systems such as exchange carrier switch 110). Exchange carrier switch 110 accesses service control server 112 to perform look-ups of long distance numbers it receives from a customer device 102 over PSTN network 106. Based upon the results of the look-ups, service control server 112 returns routing instructions for the call to exchange carrier switch 110, which in turn, places the call. Exchange carrier switch 110 further communicates with resource server 116 via a primary rate interface (PRI) trunk 111 and with resource server 116 and provisioning server 128 via network 108.

Service control server 112 stores databases of information such as ‘automatic number identification’ (ANI) information in a data store 115, customer best routing logic in a data store 117, and provisioning data in a data store 119. ANI information refers to directory or equipment numbers of a calling party, such as customer device 102, that are automatically obtained using multi-frequency (MF) signaling or via an integrated services digital network (ISDN) primary rate interface (PRI).

Customer best routing (CBR) logic refers to an analysis engine and business rules that receive as input the terminating call number (i.e., destination party number) information, the calling party information (e.g., calling party number, account code, and preferences), and analyze these inputs against vendor information. As indicated above, vendor information may include specific rates offered to customers based upon criteria such as time of day, holidays, call volumes accrued by a calling party, the geographic location of the called number, among others. Rate information of vendors, such as vendors 130A and 130B, is gathered by host system 104 and stored in service control server 112. Based upon this analysis, a customer best routing plan for the call is generated as described further herein. Service control server 112 may execute a proprietary application or may comprise the Enhanced Control Server (eCS) by Lucent Technologies® of Murray Hill, N.J.

Provisioning order data is received from provisioning server 128 for activating a call routing service account and is stored in service control server 112. The type of data that may be included in a provisioning order received from provisioning server 128 is shown in provisioning record 300 of FIG. 3. This provisioning data may be reformatted to a form usable by service control server 112. For example, the provisioning order data shown in provisioning record 300 of FIG. 3 may be converted into binary code or a format utilizing a data compression technique for facilitating the storage requirements of service control server 112. Service control server 112 communicates with resource server 116, billing server 103, and provisioning server 128 via packet-switched network 108 or similar means.

Resource server 116 enables a service provider of host system 104 to provide enhanced customer services such as those provided by the call routing system. Resource server 116 includes text-to-speech capabilities and supports multimedia and multi-lingual requirements. Resource server 116 may execute a proprietary application or may comprise the Enhanced Media Resource Server (eMRS) by Lucent Technologies®. Resource server 116 executes an application and user interface 118 for implementing the call routing system services (also referred to as CBR application and user interface 118). For example, the user interface 118 may communicate with customers (e.g., prompts) using voice, text, and/or multi-media formats depending upon the type of calling device (e.g., 102) used by the customer.

Resource server 116 is in communication with a data repository 120, which stores databases of customer records 122. Customer records 122 store phone numbers for customers of the service provider of host system 104 which are used to both validate customers seeking to activate a call routing system account, as well as to associate each customer phone number with an existing call routing service account (e.g., via an account code).

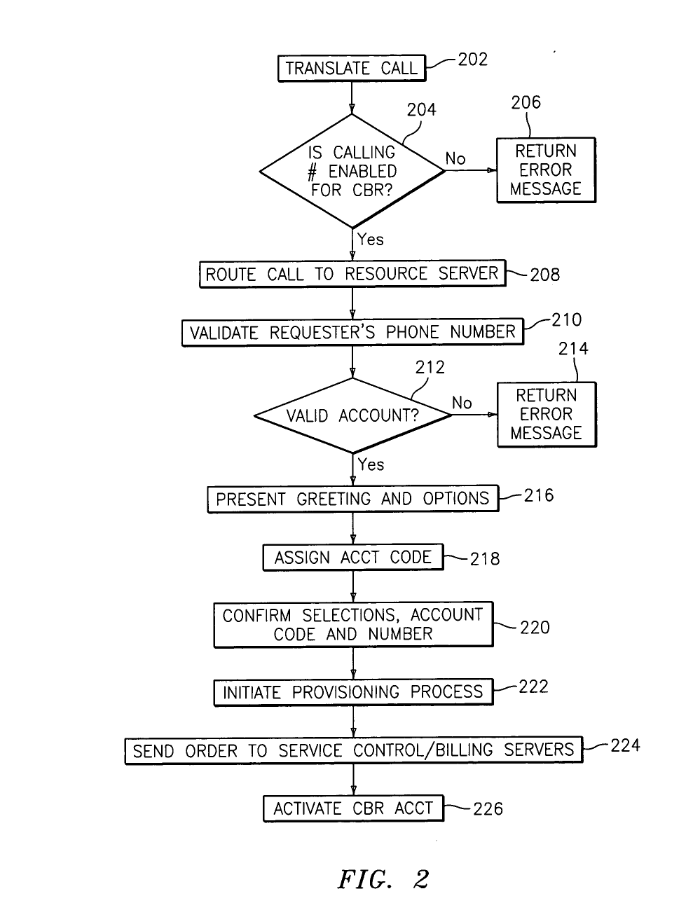

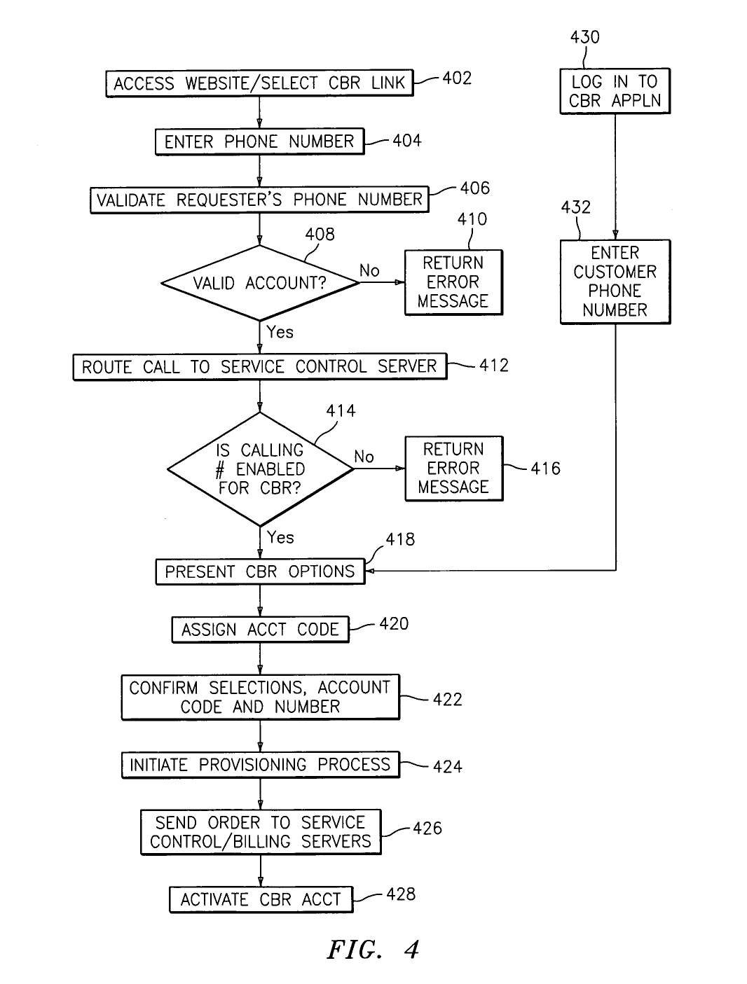

Provisioning server 128 provisions the databases for intelligent network services such as the call routing system application and user interface 118 as well as voice files running on the intelligent network platform. Similar to the resource server 116, provisioning server 128 is also in communication with data repository 120. Resource server 116 handles the processing of call routing service accounts initiated by customers via telephone or over the Web. Provisioning server 128, on the other hand, handles the processing of call routing service accounts by a manual entry process initiated by an account manager or representative of the telecommunications service provider of host system 104 on behalf of a customer. This processing is described further in FIGS. 2 and 4.

Provisioning server 128 receives provisioning orders from resource server 116 and/or via manual input directly into provisioning server 128. Provisioning order data may be in text format. Provisioning server 128 reformats the data into a form usable by service control server 112. For example, the provisioning data may be compressed to facilitate the limited storage requirements of service control server 112. This reformatted provisioning data is transmitted to service control server 112 via network 108. Provisioning server 128 may execute a proprietary application or may execute the Enhanced Services Manager (eSM) by Lucent Technologies®.

Provisioning server 128 may also store records 129 of provisioning orders as a back-up security measure in the event of a system failure. A sample provisioning record is shown and described with reference to FIG. 3. Provisioning server 128 may also manage other services offered in addition to the call routing services described herein. In alternate embodiments, a single server may be utilized to provide the functionality described above with respect to resource server 116 and provisioning server 128.

Data repository 120 may be a separate physical storage device that is addressable by servers 116 and 128 as shown in the system of FIG. 1. It will be understood, however, that data repository 120, server 116, and/or server 118 may alternatively comprise a single unit, such as a mainframe computer, and that they are shown as separate units in the system of FIG. 1 for purposes of illustration.

Embodiments include initiating activation of the call routing system services from a business telephone (e.g., wireline phone linked to a toll-free number allocated by host system 104 specifically for these services) for security purposes. However, it will be understood that activation may occur from an alternate location or device if sufficient security measures are adopted to prevent unauthorized activation of call routing service accounts and other system abuses. Embodiments include activating the call routing system services using next generation network technologies such as voice over Internet protocol (VoIP), whereby a customer communicates with host system 104 via a computer-enhanced device such as a personal computer, web-enabled mobile telephone, and similar digital devices. Exemplary embodiments further include manual activation of a call routing system account by an account manager or representative of host system 104.

Activating a call routing service account that is initiated via a telephone over a PSTN 106 will now be described with reference to FIG. 2. A calling party who is interested in receiving the call routing services calls a number provided by the service provider of host system 104 (e.g., a number designated for setting up new call routing service accounts). The call is received at exchange carrier switch 110, which in turn, routes the call to service control server 112. Service control server 112 translates the call at step 202 as described in the system shown in FIG. 1. Service control server 112 determines the calling party number (e.g., by using an automatic number identification (ANI) feature).

Once the number has been identified, service control server 112 determines whether the calling party's number is enabled for call routing services at step 204 (e.g., whether the calling party's number/location supports call routing services). If not, an error message is returned to the calling party at step 206. If the number is confirmed to be call routing-enabled at step 204, the call is then routed via carrier switch 110 to resource server 116 over trunk 111 at step 208. Resource server 116 validates the calling party's identity by comparing the calling party's phone number (e.g., the telephone number from which the calling party placed the call and which is tied with the calling party's telecommunications service account) with customer records 122 in data repository 120 at step 210. This step validates whether the calling party is an existing customer and whether the customer has a valid customer account. If it is determined that the calling party is not a valid customer at step 212, an error message is transmitted to the calling party at step 214. This may be a voice recording that is activated by resource server 116 and presented to the calling party via carrier switch 110 and PSTN 106.

If it is confirmed that the calling party is a valid customer at step 212, resource server 116 presents a recorded greeting to the customer, along with options for directing the customer to activate the call routing service account at step 216. The prompts may include instructions for selecting user preferences as described further with reference to FIG. 3. The prompts may also include terms and conditions of the call routing services. In response to the customer's responses to these instructions, resource server 116 assigns a unique account code to the customer at step 218. The account code ties the customer to the call routing service and the selected preferences. Resource server 116 confirms the selections, account code(s), and customer number and then prompts the customer to accept the call routing service account and its terms and conditions at step 220.

The provisioning process is then initiated by the resource server 116 at step 222. The provisioning process includes generating a provisioning order by resource server 116 and transmitting the provisioning order to provisioning server 128. Provisioning server 128 sends the provisioning order to service control server 112 to provision the call routing service account and also to billing server 103 at step 224. Billing server 103 updates its customer billing records to reflect that this customer is a call routing service subscriber for billing purposes. Service control server 112 activates the call routing service account at step 226.

A customer may modify and/or cancel his/her call routing service by calling the number designated for the call routing system and following the prompts to either modify or cancel the service. The process steps for modifying and canceling service are similar to those described above with respect to activating the service.

As indicated above, host system 104 gathers vendor pricing information and stores it in service control server 112. A portion of the type of vendor information that may be gathered is provided below with respect to three vendors.

Rate

Vendor 1

| | | |
|---|---|---|
| Location | Boston to San Francisco | |
| Time of Day | 1300-1700 | |
| Day of Week | Sunday-Saturday | .07/min. |
| Time of day | after 1700 | |
| Day of Week | Sunday-Saturday | .06/min. |
| Day of Year | 12/24 | .12/min. |

Vendor 2

| | | |
|---|---|---|
| Location | Boston to San Francisco | |
| Time of Day | 1300-1700 | |
| Day of Week | Monday-Friday | .09/min. |
| | Saturday, Sunday | .05/min. |
| Time of Day | after 1700 | |
| Day of Week | Sunday-Saturday | .05/min. |

Vendor 3

| | | |
|---|---|---|
| Location | Boston to San Francisco | |
| Time of Day | 1300-1700 | |
| Day of Week | Monday-Friday | .05/min. |
| | Saturday-Sunday | .04/min. |
| Time of Day | after 1700 | |
| Day of Week | Sunday-Saturday | .04/min. |

A customer may select preferences for calls made via the CBR application and user interface 118. Preference criteria may include a time of day, day of week, day of year, percent allocation, or other suitable elements. For example, a customer may prefer that all calls made Monday through Friday be routed via Vendor 1. This preference is established by the Day of Week option provided by prompts provided to the customer either by an automated voice system or web interface executing on resource server 116, or by manual entry by a representative of host system 104 via provisioning server 128. Another preference may be the allocation of call routing to vendors (e.g., 50% of all calls made go through Vendor 1, 50% through Vendor 2, and 0% through Vendor 3). Further, a customer may prefer to default the routing in accordance with best rates available from each of the vendors. For example, because Vendor 2 offers lower rates for calls between Boston and San Francisco on Saturday and Sunday after 5:00 p.m., the call routing system would select Vendor 2 for these calls. These preferences are stored in provisioning record 300 as shown in FIG. 3.

Upon establishing a call routing service account, a provisioning record 300 is generated, which includes a phone number 302 for the calling party customer, the unique account code assigned to the customer, the date of service (i.e., when the account was activated), and customer preferences 304. Date fields 306 refer to the day of week/day of year preference, time fields 308 refer to the time of day preference, location field 310 refers destination of the terminating call, and percent allocation field 312 refers to the customer-preferred allocation of calls routed through specific vendors. A customer (e.g., a business entity) may further set preferences by department (via field 316), and/or employee/phone line/extension (via field 318) by selecting ‘by group’ field 314. For example, an employee of the business customer may be authorized to customize his/her own preferences as long as they do not conflict with the global preferences selected by the business customer. The employee would be assigned his/her own unique account code for this purpose.

As indicated above, embodiments include activating a call routing service account that is initiated via a packet-switched network and/or a manual entry process. These are described with reference to FIG. 4. A request for an account initiated via the Web is described in steps 402-428. A request for an account initiated via manual entry processes is described in steps 430, 432 and 418-428. A requesting party accesses a website provided by resource server 116 via host system 104 at step 402. The requesting party selects a link to the call routing service web page. The requesting party is then prompted to enter a phone number for the new account at step 404. Resource server 116 validates the phone number at step 406 by comparing the number entered with numbers stored in customer records 122. At step 408, it is determined whether the phone number represents a valid customer of the service provider. If not, resource server 116 returns an error message at step 410.

If the phone number represents a valid customer at step 408, the call is routed to service control server 112 at step 412. Service control server 112 determines whether the phone number is CBR-enabled at step 414. If not, an error message is returned. Otherwise, the call is returned to resource server 116 and call routing service options are presented to the customer at step 418. These options include prompting the customer for selecting preferences for the call routing service account. Once the selections have been made, resource server 116 assigns a unique account code to the customer at step 420 and prompts the customer to confirm the selections at step 422. The provisioning process is initiated at step 424. Steps 424-428 are similar to steps 222-226 described with reference to FIG. 2.

Embodiments include initiating a call routing service account via a manual process as described in steps 430, 432, and 418-428. A marketing representative or account manager for the service provider may be tasked with soliciting business customers either in person or by telephone to activate a call routing service account. The representative would only solicit those parties with valid customer accounts and which are known to be CBR-enabled. Thus, in exemplary embodiments, the steps recited in 402-416 would not be performed at the time of account activation but would occur in advance of activation. At step 430, the representative logs into the CBR application and user interface 118 and enters the customer telephone number at step 432. The CBR application and user interface presents options for selection at step 418. The representative would enter the customer's preferences obtained from the customer either via telephone, responses provided in a questionnaire or account form, or other means. The process continues to step 420 as described above.

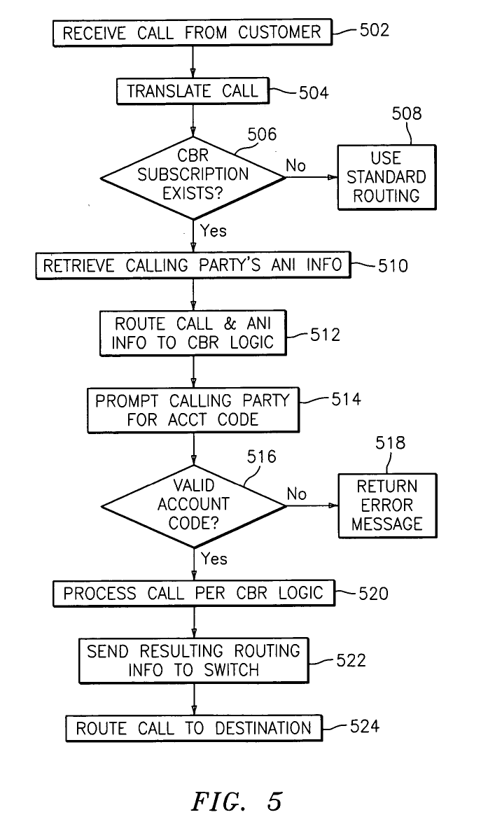

Once an account has been activated, the call routing system may be implemented by a customer placing an outgoing call as described in reference to FIG. 5. At step 502, the call is received by carrier exchange switch 110 for the customer via a telephone (e.g., customer device 102). The call is transferred to service control server 112 for translation at step 504. Service control server 112 searches provisioning data in data store 119 for the calling party's number to see if a subscription for the call routing service exists for the customer at step 506. If no subscription is found, the call is routed using standard routing procedures at step 508 (e.g., regular rates apply). If, on the other hand, a subscription for the call routing service is found for the calling party, the service control server 112 retrieves customer ANI information in data store 115 for the calling party at step 510 and then routes the call and the customer ANI information to CBR logic in data store 117. The CBR logic is applied to the call and the vendor information at step 512.

The call is then routed to resource server 116, which prompts the calling party for his/her account code at step 514. The account code is compared with the customer records 122 in data repository 120 to determine whether the account code is valid at step 416. If not, resource server 116 returns an error message to the customer at step 518.

If valid, the call is processed according to the CBR logic in data store 117 at step 520. The processing results in an optimized routing plan, which is transmitted to exchange carrier exchange switch 110 at step 522. Using this routing plan, exchange carrier switch 110 routes the call to its destination at step 524. Billing server 103 is notified of this transaction and the customer's billing account is updated accordingly.

As can be seen from the above, the call routing system provides customized routing of calls for business customers in order to meet their specific dial plan needs and reduces costs by routing calls via specific carriers or internal routes based upon pre-established criteria such as the time of day, day of week, time of year, and percentage allocations.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing call routing services, comprising:
retrieving vendor pricing data in response to a call received from a caller, said call seeking termination at a destination party number;
retrieving customer preference data for said caller;
analyzing said vendor pricing data and said customer preference data in light of said destination party number;
generating a call routing plan resulting from said analyzing; and
executing said call in accordance with said call routing plan.

2. The method of claim 1, further comprising:
upon said executing said call, updating a billing account for said caller.

3. The method of claim 1, wherein said vendor pricing data includes available rates offered and categorized by at-least one of:
time of day;
day of week;
day of year;
location of calling party; and
location of destination party.

4. The method of claim 3, wherein said customer preference data is operable for selecting a vendor for handling call routing based upon at least one of:
said vendor pricing data;
customer personal preference; and
percentage allocation including allocating call transmissions between at least two vendors.

5. The method of claim 1, wherein said generating a call routing plan includes selecting a vendor to execute transmission of said call.

6. A method for establishing a call routing service account, comprising:
receiving a request for said call routing service account from a caller, said caller identified by a calling party number;
prompting said caller to select call routing preferences;
assigning an account code to said calling party number; and
activating said call routing service account for said caller;
wherein said call routing preferences are selectable based upon at least one of:
vendor pricing data;
customer personal preference; and
percentage allocation.

7. The method of claim 6, further comprising:
associating said call routing service account with a billing account for said caller.

8. The method of claim 7, wherein said vendor pricing data includes available rates offered and categorized by at least one of:
time of day;
day of week;
day of year;
location of calling party; and
location of destination party.

9. The method of claim 6, wherein said percentage allocation includes allocating call transmissions between at least two vendors.

10. The method of claim 6, wherein initiation of said request for a call routing service account occurs via at least one of:
a public-switched telephone network;
a packet-switched network; and
a manual entry process.

11. A system for providing call routing services, comprising:
a service control server storing vendor pricing data and customer preference data; wherein in response to a call received from a caller, said service control server retrieves said vendor pricing data and said customer preference data;
an analysis engine executing on said service control server, said analysis engine operable for:
analyzing said vendor pricing data and said customer preference data in light of a destination party number associated with said call; and
generating a call routing plan resulting from said analyzing; and
at least one vendor system in communication with said service control server, said at least one vendor system identified in said call routing plan; wherein said at least one vendor system executes said call in accordance with said call routing plan.

12. The system of claim 11, further comprising a billing server in communication with said service control server, said billing server operable for updating a billing account for said caller upon execution of said call routing plan.

13. The system of claim 11, wherein said vendor pricing data includes available rates offered and categorized by at least one of:
time of day;
day of week;
day of year;
location of calling party; and
location of destination party.

14. The system of claim 13, wherein said customer preference data is operable for selecting a vendor for handling call routing based upon at least one of:
said vendor pricing data;
customer personal preference; and
percentage allocation including allocating call transmissions between at least two vendors.

15. The system of claim 1 1, wherein said generating a call routing plan includes selecting a vendor to execute transmission of said call.

16. A storage medium encoded with machine-readable program code for providing call routing services, said program code including instructions for causing a server to implement a method, comprising:
retrieving vendor pricing data in response to a call received from a caller, said call seeking termination at a destination party number;
retrieving customer preference data for said caller;
analyzing said vendor pricing data and said customer preference data in light of said destination party number;
generating a call routing plan resulting from said analyzing; and
executing said call in accordance with said call routing plan.

17. The storage medium of claim 16, further comprising instructions for causing said server to implement:
upon said executing said call, updating a billing account for said caller.

18. The storage medium of claim 16, wherein said vendor pricing data includes available rates offered and categorized by at least one of:
time of day;
day of week;
day of year;
location of calling party; and
location of destination party.

19. The storage medium of claim 18, wherein said customer preference data is operable for selecting a vendor for handling call routing based upon at least one of:
said vendor pricing data;
customer personal preference; and
percentage allocation including allocating call transmissions between at least two vendors.

20. The storage medium of claim 16, wherein said generating a call routing plan includes selecting a vendor to execute transmission of said call.
